(19) United States
(12) Patent Application Publication
(10) Pub. No.: US 2004/0146647 A1
(43) Pub. Date: Jul. 29, 2004

(54) Patterning method

(76) Inventors: Gregory Peter Wade Fixter, Farnborough (GB); Daniel Robert Johnson, Farnborough (GB); William Norman Damerell, Farnborough (GB); Stephen George Appleton, Farnborough (GB)

Correspondence Address: NIXON & VANDERHYE, PC, 1100 N GLEBE ROAD, 8TH FLOOR, ARLINGTON, VA, 22201-4714, US

(21) Appl. No.: 10/479,643

(22) PCT Filed: May 23, 2002
(86) PCT No.: PCT/GB02/02412

(30) Foreign Application Priority Data
Jun. 4, 2001 (GB) 0113408.9
Nov. 29, 2001 (GB) 0128571.7

(51) Int. Cl. B05D 3/10; B05D 5/00

(52) U.S. Cl. 427/256; 427/304; 427/305

(57) ABSTRACT

A method of preparing a substrate material such that it is capable of sponsoring a catalytic reaction over a pre-determined area of its surface comprising coating some or all of the substrate material with a catalytic material which is capable, once the coated substrate is introduced into a suitable catalytic reaction environment, of sponsoring a catalytic reaction over the coated areas of the substrate wherein the catalytic material is printed onto the substrate by a pattern transfer mechanism.

This invention relates to a method of forming high resolution patterns of material on a substrate and encompasses the field of catalytic reactions (especially autocatalytic coating methods).

Autocatalytic plating is a form of electrode-less (electroless) plating in which a metal is deposited onto a substrate via a chemical reduction process. The advantage of this technology is that an electric current is not required to drive the process and so electrical insulators can be coated. Coatings derived by this technique are usually more uniform and adherent than from other processes and can be applied to unusually shaped surfaces (see Deposition of Inorganic Films from Solution, Section III Ch 1 pp 209-229; Thin Film processes (1978); Publishers Academic Press and, Smithells Metals Reference Book, 7^{th} Edition (1992) Chapter 32, pp12-20; Publishers Butterworth Heinmann.)

Processes exist for the autocatalytic deposition of a large number of metals, particularly cobalt, nickel, gold, silver and copper from a suitable solution bath.

Basically, the solutions contain a salt of the metal to be deposited and a suitable reducing agent, e.g. hypophosphite, hydrazine, borane etc. When a metal substrate, which is catalytic to the reaction, is introduced into the solution bath it becomes covered with a layer of the coating metal which itself is catalytic so that the reaction can continue.

Deposition will only occur if conditions are suitable on the substrate to initiate and then sustain the autocatalytic process. Therefore in cases where the substrate is a plastic or ceramic, for example, additional steps are required to create suitable surface properties. Usually, in such cases the substrate is “sensitised” with a reducing agent, e.g. SnCl₂. Also, the surface may be “activated” with a thin layer of an intermediate catalytic material, e.g. Palladium (itself a candidate metal for autocatalytic deposition), in order to aid the deposition process. Such “deposition promoting materials” are generally referred to in the literature as “sensitisers” and “activators” respectively.

Autocatalytic deposition is generally employed to coat whole surfaces. However, in order to form metal patterns, e.g. for electrical circuits or decorative effects, additional processes such as photolithography followed by etching of surplus metal have to be performed. There are disadvantages to these additional processes, including inflexibility, long lead times, increased costs and the use of excessive materials to provide coatings much of which is then subsequently removed as waste.

There are many types of catalytic reaction (including the autocatalytic reaction described above) that can take place over the surface of a substrate material and such reactions can be used to increase the rate of or activate reactions in gas, liquid or solid environments.

The “catalytic materials” that are used in such reactions include “deposition promoting materials” (as defined above) but also include other heterogeneous catalysts and homogeneous catalysts. Heterogeneous catalytic materials include metals such as platinum, rhodium and palladium and metal oxides containing catalytic sites, e.g. perovskite cage structures. These catalysts are used in synthetic or decomposition reactions in organic or inorganic chemistry, for example in the Fischer-Tropsch synthesis of organic molecules from hydrogen and carbon monoxide, cracking, or in the decomposition of hydrocarbons. Homogeneous catalytic materials include enzymes which are used, for example in biochemical testing in diagnostic arrays and for de-compositional analysis of biopoloymers and systems that mimic proteozone behaviour. Homogeneous catalysts also include negative catalysts, commonly known as inhibitors, which moderate reactions.

Generally in such reactions the catalytic material used is either applied to or is effective over the whole of the substrate material and as a consequence the reaction takes place over the whole of the substrate.

It is therefore an object of the present invention to provide a method of preparing a substrate material such that it is capable of initiating a catalytic reaction over a pre-determined area of its surface.

Accordingly, this invention provides a method of preparing a substrate material such that it is capable of sponsoring a catalytic reaction over a pre-determined area of its surface comprising coating some or all of the substrate material with a catalytic material (as hereinbefore defined) which is capable, once the coated substrate is introduced into a suitable catalytic reaction environment, of sponsoring a catalytic reaction over the coated areas of the substrate wherein the catalytic material is printed onto the substrate by a pattern transfer mechanism.

By using pattern transfer mechanisms, such as, inkjet printing, screen printing, pen writing or spray printing, the catalytic material can be laid down onto the substrate in a pre-determined pattern. When the substrate is subsequently immersed into a suitable catalytic reaction environment the desired catalytic reaction will occur only on the patterned areas of the substrate covered by the catalytic material. Surrounding areas of the substrate will be unaffected.

The minimum feature sizes that result from the use of a pattern transfer technique are dependent on the particular mechanism used. For an ink jet printing technique features of the order 20 microns are possible. Screen printing and/or pen writing result in much coarser features being produced, e.g. up to 1000 microns. Features in the range 20-1000 microns are therefore possible depending on the mechanism used.

The use of a pattern transfer mechanism removes or at least greatly reduces the need for any processing (such as etching etc.) after the desired catalytic reaction has taken place. Therefore the amount of wasted material is reduced and the overall process is simplified which leads to cost savings.

Conveniently, the catalytic material can be synthesised from the printing of inks containing reagents that react together at a printed surface or can be contained directly in an ink formulation suitable for use with the chosen pattern transfer mechanism.

Conveniently the ink formulation can, in addition to the catalytic material, contain binders and fillers which can enhance the properties of the intended catalytic process.

Any organic/inorganic material that will solidify or “set” and be adhered to the printable surface of the substrate may be used as a binder. Examples may be ink solutions containing polymers e.g. poly(vinyl acetate), acrylics, poly(vinyl alcohol) and/or inorganic materials that behave as cements or sol-gels coatings, e.g titanium isopropoxide and other alkoxides.

Fillers comprise insoluble particles contained in the ink that are small enough to transfer from the printer mechanism. Typically, 10-200 nm carbon black particles are added to colour inkjet inks and 1-100 micron graphitic carbon is added to screen-printable inks used in the fabrication of printed electrical conductors. Ceramics, organic dyes or polymer particles may be added to ink to provide colour and/or texture in the printed product e.g. titania, alumina, mica, glass, acrylics. The ink may therefore be formulated with any of these components and include the deposition promoting material to provide a wide range of properties.

Once the substrate has been prepared in the manner described above then it can be introduced into a reaction environment suitable to initiate the required catalytic process. For example, if the chosen catalytic reaction is an autocatalytic coating method then the final stage of the process is to deposit a metal into the scribed areas. This can be achieved by immersing the substrate in a suitable autocatalytic solution bath. In general terms the catalysed surface may be exposed to any reaction environment, including gas, vapour, liquid, solution or solid.

Certain catalytic reactions (such as the autocatalytic reaction above) will result in material being deposited onto the prepared substrate and in such cases the process according to the invention can be repeated in order to build up multiple material layers/patterns. Insulator layers can also be added to separate these different layers.

Autocatalytic reactions are used to deposit metal onto a substrate. Such processes are generally used to deposit whole surfaces. However, the process according to the present invention can be used to deposit metal patterns in a pre-determined user defined manner. To deposit a metal coating the catalytic material is chosen to be a deposition promoting material. The prepared substrate in this case will then be suitable for subsequent metal plating by immersion in a suitable autocatalytic deposition solution.

The metal coating which is deposited by the autocatalytic deposition process may then also subsequently be coated with further metals through electroless deposition, provided the first metal coating surface can catalyse or ion exchange with the subsequent metals. For example a sensitised substrate may be autocatalytically coated with a layer of nickel which could then be further coated, via a further electroless process, with a coating of copper. Alternatively, if the first electroless coating is copper a further coating of tin may be deposited.

It is also possible for the autocatalytic deposition solution to contain two different metal salts which are then co-deposited onto a sensitised substrate at the same time, for example nickel and copper.

An autocatalytically deposited metal pattern may also be further coated with a wide range of metals or compounds by electrodeposition, provided there are continuous electrical paths in the pattern to act as the cathode of an electrolytic bath. An example is the electrodeposition of “chromium” plate onto nickel to prevent tarnishing.

The deposition promoting material may comprise a reducing agent (a “sensitiser”) such as SnCl₂, glucose, hydrazine, amine boranes, borohydride, aldehydes, hypophosphites, tartrates. The reducing agent(s) can be dissolved into one or more of the following polar solvents in order to form a suitable ink formulation; water, methanol, industrial methylated spirit (IMS), isopropyl alcohol, butyl acetate, butyl lactate, diethylene glycol, diethylene glycol butyl ether, 1-phenooxy-2-propanol, dipropylene glycol and glycerol. Other suitable solvents exist which would be capable of performing the same purpose as the above examples.

As an alternative to, or as well as, a reducing agent, the deposition promoting material could be an activator such as a colloidal dispersion of a catalytic material. For example palladium, cobalt, nickel, steel or copper could be added to an ink formulation to catalyse a particular metal deposition.

As a further alternative, the deposition promoting material could be one that is able to ion exchange with the catalytic material contained within the autocatalytic solution bath. For example, Ni or Fe could be added directly to an ink formulation. Once the coated substrate is introduced into the autocatalytic solution bath the deposition promoting material undergoes ion exchange with the metal in the autocatalytic solution, thereby nucleating deposition of the electroless coating.

Conveniently, the ink formulation can, in addition to the deposition promoting material, contain binders and fillers which variously can enhance the properties of the final metal coating, enhance the adhesion of the electroless metal to the substrate and which can provide porous and textured surface effects, which can change the mechanical, thermal, electrical, optical, and catalytic properties of depositing metal.

The inclusion of binders in the ink formulation may additionally serve to prevent loss of adhesion from the printed substrate of the deposition promoting agent during electroless coating. The inclusion of fillers may serve to improve contact between the deposition promoting agent and the autocatalytic solution bath.

As an alternative to including binders and fillers within the ink formulation the substrate may incorporate a porous layer which can influence the adhesion, scratch resistance and texture of the subsequent electroless metal coating.

Where a chemical reducing agent is deposited onto a substrate to become the deposition promoting agent, the method may conveniently comprise a further step of immersing the now “sensitised” substrate into an intermediate solution bath of reducible metal ions (prior to the final autocatalytic solution bath), to provide an “activating” metal overlayer on the deposition promoting agent. This further step has the effect of aiding the deposition promoting material and promoting easier deposition of certain metals (such as copper, nickel and cobalt).

For example, for the case of an ink formulation containing SnCl₂ as the deposition promoting material, once the substrate material has had the SnCl₂ applied to it, it can be immersed into an intermediate solution bath comprising a dilute aqueous solution of PdCl₂. This causes the deposition of Pd metal onto the areas of the substrate coated with the deposition promoting material. If the Pd “activated” substrate is now immersed into an autocatalytic solution then autocatalytic deposition will take place onto the Pd metal. Such an intermediate step is useful in cases where the metal to be deposited from the autocatalytic deposition bath is either copper, nickel or cobalt.

As an alternative to the above the ink formulation could contain PdCl₂ instead of SnCl₂. Following deposition of this onto the substrate, an intermediate step could be to convert the PdCl₂ on the surface of the substrate to Pd metal by immersion in a dilute aqueous solution of SnCl₂. Immersion in an autocatalytic deposition bath could then take place as before.

In a further alternative, the intermediate step could be omitted by using a “reduced” complex as the deposition promoting material, i.e. the deposition promoting material could be formulated to contain a combination of chemical species comprising both a reducing agent and an activator. For example, both SnCl₂ (sensitiser) and PdCl₂ (activator) could be added to the ink formulation. Following deposition of this onto the substrate material the substrate could be introduced immediately into the autocatalytic deposition solution to deposit the metal of choice.

Embodiments of the present invention will now be described with reference to the accompanying drawings in which:

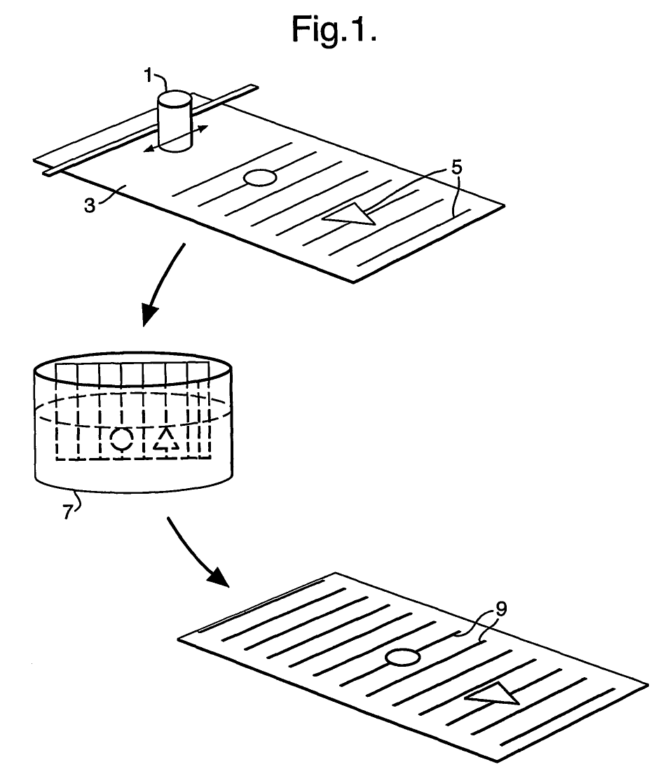

FIG. 1 shows the three stage process of producing a metallised substrate using an ink jet printing system.

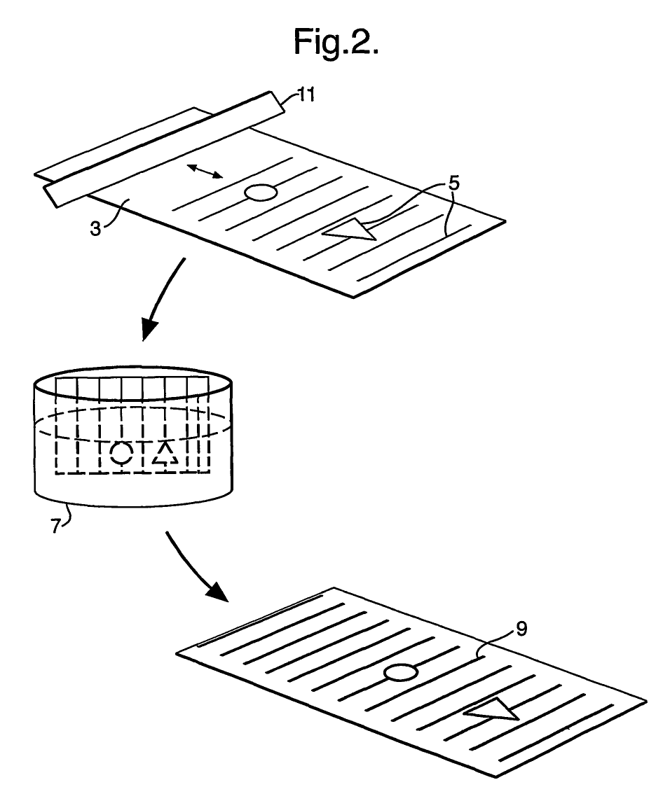

FIG. 2 shows the three stage process of producing a metallised substrate using a screen printing process.

Turning to FIG. 1, an ink jet printing system 1 coats a substrate 3 with an ink formulation containing a deposition promoting material in a user determined pattern 5. The treated substrate 3, 5 is then immersed in an autocatalytic deposition solution 7 to produce a user determined metalised pattern 9.

Ink jet printers operate using a range of solvents normally in the viscosity range 1 to 50 centipoise.

Turning to FIG. 2, a screen printing system 11 coats a substrate 3 with an ink formulation containing a deposition promoting material in a user determined pattern 5 (like numerals being used to denote like features between FIGS. 1 and 2). The treated substrate is once again immersed in an autocatalytic deposition solution 7 to produce a user determined metalised pattern 9.

A range of ink formulations according to the present invention have been tested as detailed below. All the printing inks considered below meet the following criteria:

1) They contain materials that are able to pass through the chosen printing mechanism (either an Epson 850 inkjet system or a Dek screen printer);

2) They contain liquids with the correct properties for the printing process, for example suitable viscosity, boiling point, vapour pressure and surface wetting;

3) Where suitable they contain binders and fillers affecting either the viscosity or physical printing properties of the printed ink.

### EXAMPLE 1

As discussed above it is sometimes convenient to immerse a substrate that has been coated with a deposition promoting material that comprises a reducing agent into an intermediate solution bath of reducible metal ions (prior to the final autocatalytic bath) in order to provide an “activating” metal overlayer.

In this example a tin compound was dissolved into a polar solvent in order to form the inkjet formulation. This formulated ink was then printed onto a polyester substrate and allowed to dry. The coated substrate was then introduced into an intermediate solution of a metal salt in aqueous solution.

In this example a compound of tin SnCl₂.2H₂O was dissolved into ethyl lactate to form an ink formulation of concentration in the range 1-100 millimolar (preferably 2-20 millimolar).

Three varieties of this ink formulation were prepared. The first was an ink-jet formulation simply using the above prepared solution. The second was an inkjet formulation that additionally comprised an additional 1% by weight ethyl cellulose binder. Both of these inks were printed onto a polyester substrate.

The third ink was prepared by adding the ink formulation to a commercial screen printing ink (the TiO₂ based formulation 6018S from Acheson Industries). Additions in the range 1-100 ml of the ink formulation (preferably 10-30 ml) were added to 100 grams of the screen printing paste and mixed in. This screen printing ink formulation was printed onto a polyester substrate and dried at 60° C. for 1 hour.

Following drying each of the inkjet printed and screen printed substrates were immersed into a dilute intermediate solution made from a palladium salt. This solution was prepared using PdCl₂ in the concentration range of 1 milli-molar to 0.1 molar dissolved into de-ionised water using a second salt (e.g. ammonium chloride) to aid the process.

The substrates were immersed in this intermediate solution (concentration 10 milli-molar) for 10 minutes. The temperature of the intermediate solution was in the range 10-100° C.

Following immersion in the intermediate solution the substrates were dried and then placed into a commercial autocatalytic solution of copper. Copper was found to have been deposited on each substrate only where the pattern of reducing agent had been printed. Where the binder was used in the inkjet ink, the metal had improved adhesion to the substrate.

A second series of three substrates which were not immersed into an intermediate solution were found not to sponsor the electroless deposition of copper metal.

### EXAMPLE 2

In this example a metal compound is dissolved into a solvent to form an ink formulation which is then immersed into an intermediate solution containing a reducing agent before being immersed into an autocatalytic solution bath.

In this instance palladium chloride was dissolved into hot water (aided by addition of ammonium chloride here as an equimolar quantity and chosen from a wide range of a soluble metal salts or acids).

The concentration of the dissolved palladium ions was in the range 0.1 to 500 millimolar, but preferably 75 to 150 millimolar. The concentration of the chloride chemical used to aid dissolution was 0.1 to 500 millimolar, but preferably 75 to 150 millimolar. (Note: it will be clear to a person skilled in the art that the chemical chosen to aid dissolution can comprise any combination of chemical compounds to enable dissolution to form the solvated divalent palladium ion in a given solvent or mixture of solvents).

The solution of palladium ions was added to various quantities of a second solvent to make up a range of stock solutions. In the present example ethyl lactate was used as the second solvent. For inkjet formulations the stock solutions contained the dissolved palladium compound in the concentration range 0.1 to 50 millimolar, but preferably 1 to 10 millimolar. For screen printing formulations stock solutions were prepared with concentrations in the range 0.1 to 100 millimolar but preferably 5 to 25 millimolar.

Two inkjet inks were formulated. The first comprised the stock solution alone and the second contained 1% of ethyl cellulose dissolved to act as a binder.

Also, a third screen printing ink was prepared by mixing together 100 to 1000 millilitres but preferably 50 to 200 millilitres of the screen printing stock solution to 1000 grams of a Acheson industries 6018S TiO₂ based screen printing ink.

Using the same respective printers employed in example 1, the three inks were each printed into user defined patterns on sheets of polyester and the printed surfaces dried.

A representative number of printed sheets from each ink system were then immersed at 50° C. in an aqueous solution of a reducing agent. In the present example SnCl₂.2H₂O was used in the concentration range 0.1 to 500 millimolar, but preferably 10 to 50 millimolar. After 10 minutes the sheets were removed, rinsed with water and dried. The sheets were then immersed into a commercial autocatalytic copper solution bath and copper metal deposited only onto the printed patterns of ink. A second series of sheets that were not immersed in the SnCl₂.2H₂O solution did not undergo autocatalytic deposition of copper.

### EXAMPLE 3

In this example the ink contains a colloidal dispersion of either a catalytic or autocatalytic metal.

In the case where the print transfer mechanism was screen printing, a screen printing paste was prepared that contained a low to moderate loading of metal powder in the range 1-30%. In this example Acheson 6018S TiO₂ paste was mixed with a cobalt powder f particle size 5 μm to 25% by weight of metal. After printing and drying an autocatalytic layer of cobalt was deposited onto the printed features (Acheson paste without the cobalt metal dispersion was not autocatalytically coated with cobalt).

In the case where the print transfer mechanism was inkjet printing a “reduced complex” was prepared in several inks for use as the “deposition promoting material”.

Inks 1 and 2.

A palladium compound (Palladium chloride) was first dissolved into hot water aided by the addition of an amount of a second compound, in this instance CaCl₂. 2H₂O chosen from a wide range of soluble compounds. The solution had a concentration range of the dissolved palladium ions of 0.1 to 500 millimolar, but preferably 75 to 150 millimolar. The concentration of the chloride-containing chemical used to aid dissolution was 10 millimolar to 10 molar, but preferably 0.1 to 7.5 molar.

To this palladium containing solution was then added a suitable organic solvent which also contained a reducing agent. In the present example ethyl lactate was chosen (as the solvent) and contained a tin(II) compound (as the reducing agent) dissolved to a concentration of 0.1 to 100 millimolar, but preferably 1 to 20 millimolar. (Note: other suitable solvents include water, methanol, industrial methylated spirit (IMS), isopropyl alcohol, butyl acetate, ethyl lactate, butyl lactate, diethylene glycol, diethylene glycol butyl ether, 1-phenoxy-2-propanol, dipropylene glycol Dimethyl sulfoxide (DMSO) and glycerol. Other suitable reducing agents include copper, nickel and those from platinum series metals, e.g. platinum and palladium.).

The final solution, the “reduced complex”, was therefore SnCl₂.2H₂O, and additionally palladium chloride in the range 0.1 to 500 millimolar, but preferably 1 to 20 millimolar and 0.01 to 10 molar of the second compound CaCl₂, but preferably 0.1 to 0.5.

The solution of palladium chloride on addition to the tin(II)-containing solution changed colour from light to deep orange as a consequence of the formation of a reduced complex. The reduced complex was also found to be more stable with increasing anion concentration from the second compound.

Ink 1 used the final solution alone, whereas Ink 2 contained an additional 1% ethyl cellulose by weight dissolved into it, to act as a binder. Both inks were printed to form a pattern onto separate sheets of polyester chosen from a wide range of suitable materials. After drying the patterns they were immersed into an autocatalytic nickel solution and nickel deposited only onto the patterns.

Inks 1 and 2 have the advantage of using low acidity components to achieve stable formulations, thereby avoiding precipitation of the catalytic activator, and possible risk of the printer mechanism becoming blocked.

Inks 3 and 4

These were prepared using palladium chloride dissolved into hot water, in this instance using hydrochloric acid to aid dissolution. The palladium concentration was in the range 0.1 to 500 millimolar, but preferably 75 to 150 millimolar and the hydrochloric acid was 0.1 to 13 molar but preferably 0.5 to 6 molar. To this was added a suitable organic solvent which contained a reducing agent. In the present example ethyl lactate was the solvent and contained a tin(II) compound as SnCl₂.2H₂O, dissolved to a concentration of 0.1 to 100 millimolar, but preferably 1 to 20 millimolar.

The final solution therefore contained in addition to the tin compound, 0.1 to 500 millimolar (but preferably 1-20 millimolar) of palladium chloride and 0.01 to 10 molar (but preferably 0.1-0.5 molar) of the hydrochloric acid. The solution of palladium chloride on addition of the tin(II)-containing solution changed colour from light to deep orange owing to the formation the reduced complex.

Ink 3 comprised this final solution alone and ink 4 contained additionally 1% by weight ethyl cellulose dissolved as a binder. The two inks were printed and dried onto separate sheets and immersed into an autocatalytic nickel solution bath where nickel deposited solely onto the printed areas. Both inks appeared to have a good shelf life using hydrochloric acid in the concentration range 0.05 to 0.5 molar. The advantage of ink formulations using hydrochloric acid in this example is that this component once more improves the stability of the ink but yet can be removed simply by drying out of the printed layer, thus leaving a higher weight percentage loading of the catalytic activator.

Inks 5 and 6.

These were prepared using a suitable palladium compound, in this instance palladium chloride, dissolved into dimethylsulfoxide, DMSO, along with a second compound, for example CaCl₂. The palladium ion concentration was thus 0.1 to 500 millimolar, but preferably 75 to 150 millimolar and the concentration of the second compound was 10 millimolar to 10 molar, but preferably 0.1 to 7.5 molar. To this solution was added ethyl lactate to produce a resulting solution containing Pd²⁺ ions in the concentration range 0.1 to 50 millimolar, but preferably 1 to 20 millimolar and calcium chloride in the range 5 to 1000 millimolar but preferably 150 to 500 millimolar. To this a reducing agent, a tin compound, was added which in this instance was SnCl₂.2H₂O, to give a concentration of 0.1 to 100 millimolar, but preferably 1 to 20 millimolar. The solution changed from light to dark orange as a result of the formation of a dispersion containing the “reduced complex”.

Ink 5 comprised this solution alone and ink 6 contained additionally 1% by weight ethyl cellulose dissolved as a binder. The two inks were printed and dried on separate sheets and immersed into an autocatalytic nickel solution bath where nickel deposited solely onto the printed areas. Both inks appeared to have a longer shelf life using calcium chloride to aid dissolution provided that the concentration of the salt was above 0.15 molar, otherwise it decomposed like ink 1 and 2. Both inks were printed to form a pattern onto separate sheets. After drying the patterns they were immersed into an autocatalytic nickel solution and nickel deposited only onto the patterns.

Inks 7 and 8.

In this formulation the inks were prepared in the same way as inks 5 and 6 but the second compound in this instance was sodium hydroxide added to an amount to 0.1 to 500 grams per litre, but preferably 1 to 100 grams, in the DMSO solvent. To this solution was added ethyl lactate to produce a resulting solution containing Pd²⁺ ions in the concentration range 0.1 to 50 millimolar, but preferably 1 to 20 millimolar and sodium hydroxide dissolved in the concentration range 5 to 1000 millimolar but preferably 10 to 150 millimolar. To this a reducing agent was added, for example a tin compound, which in this instance was SnCl₂.2H₂O, to give a concentration of 0.1 to 100 millimolar, but preferably 1 to 40 millimolar. The solution changed from light orange to a deep claret/red colour as a result of the formation of a dispersion containing the “reduced complex”. The dispersion of the reduced complex was found to be more stable in the presence of the sodium hydroxide.

Ink 7 used this solution alone and ink 8 had an additional 1% of ethyl cellulose dissolved into it as a binder.

Dummy Inks.

As a control test inks were prepared with the same approach as inks 1 and 2 but the tin compound was omitted. The printed and dried inks were found not to support autocatalytic nickel deposition.

A second pair of inks was also prepared using the same preparation as for inks 3 and 4, but in this instance the palladium compound was omitted. Once again the printed and dried inks were found not to support autocatalytic deposition of nickel.

### EXAMPLE 4

If the deposition promoting material is a reducing agent then, for a suitably strong reducing agent, autocatalytic metals can be reduced directly from the autocatalytic solution bath. The reducing agent in this case was dimethylamine borane (DMAB) which was dissolved into ethyl lactate to form an inkjet formulation.

In this example the DMAB concentration in the ink was in the range 1-50 millimolar, but preferably in the range 1-10 millimolar. The printed and dried ink was then immersed into an autocatalytic solution of a copper salt at 50° C. and electroless copper coated only onto the printed area.

As a variant to the above formulation, 1% by weight of polyvinylbutyrate was added to the ink as a binder. The printed material coated and adhered will to the substrate, in this case a sheet of polyester. The deposition promoting material formed by the described treatment enabled the autocatalytic deposition of electroless copper to take place on the printed area and was unaffected by the presence of a binder.

Inks formed according to either of the above variants which lacked the reducing agent in the formulation were unable to sponsor electroless copper deposition.

### EXAMPLE 5

In this example a layer of colloidal metal was formed on the surface of the substrate by reducing a metal compound on the surface of the substrate by immersion in a strong reducing agent.

In this example a copper(II) compound was dissolved into ethyl lactate to form a solution of Cu²⁺ ions and inkjet printed. Any suitable copper compound and solvent combination to form a solution of Cu²⁺ ions could have been chosen, but here copper (II) chloride was used.

The copper concentration in the ink was in the range 1 to 50 millimolar, but preferably in the range 1 to 10 millimolar. The printed and dried ink was then immersed in an aqueous solution of dimethylamine borane, DMAB, in the concentration range 1 to 50 millimolar, but preferably in the range 1 to 10 millimolar at 50° C. for 5 minutes followed by rinsing in water.

The substrate was then immersed in an autocatalytic solution of a copper salt and electroless copper coated only the printed area.

In a farther variant, 1% by weight of polyvinylbutyrate was added to the ink as a binder. The printed material coated and adhered well to the substrate, in this case a sheet of polyester. Once more electroless copper deposited onto the printed area only.

A second substrate coated with this ink and not immersed in the DMAB solution and was unable to coat with copper as described. A third substrate printed with an ink having no metal salt and yet immersed into a solution of DMAB was also unable sponsor electroless copper deposition Example 6.

As described above ink jet formulations can contain filler particles such as titania and carbon black in order to enhance the effectiveness of the catalytic reaction.

In this example a standard commercial black printing ink was used, which contained carbon black filler particles able to be inkjet printed.

Separately, a palladium compound (in this case palladium chloride) was dissolved into hot water and had ammonium chloride in an equimolar quantity to aid dissolution. The concentration of the dissolved palladium ions was in the range 0.1 to 500 millimolar, but preferably 75 to 150 millimolar. The concentration of the chloride chemical used to aid dissolution was 0.1 to 500 millimolar, but preferably 75 to 150 millimolar. To this was added butyl alcohol to produce a solution where the concentration of palladium ions and second compound were in the range 0.1 to 500 millimolar, but preferably 10 to 50 millimolar. This solution which usually decomposes to a grey precipitate after a short time was instead added immediately to the commercial black printing ink in the volume ratio of 10 to 50% and allowed to decompose by coating the carbon particles instead. A printed and dried pattern of the resulting ink on a synthetic inkjet paper sheet was able to sponsor electroless metal deposition.

A second sheet with the commercial ink but without the deposition promoting material was unable to achieve electroless deposition.

The skilled man will appreciate that the above principles can be applied with different autocatalytic materials and solutions and different pattern transfer mechanisms in order to produce the desired metallised and patterned substrate. For example, the inkjet printing ink formulation relating to FIG. 1 could also be delivered onto a substrate by means of a fibre tipped pen in order to create the desired pattern.

1. A method of preparing a substrate material such that it is capable of sponsoring a catalytic reaction over a pre-determined area of its surface comprising coating some or all of the substrate material with a catalytic material (as hereinbefore defined) which is capable, once the coated substrate is introduced into a suitable catalytic reaction environment, of sponsoring a catalytic reaction over the coated areas of the substrate wherein the catalytic material is printed onto the substrate by a pattern transfer mechanism.

2. A method of preparing a substrate such that it is capable of sponsoring a catalytic reaction as claimed in claim 1 wherein the pattern transfer mechanism is inkjet printing.

3. A method of preparing a substrate such that it is capable of sponsoring a catalytic reaction as claimed in any preceding claim wherein the catalytic reagent is contained within an ink formulation.

4. A method of preparing a substrate such that it is capable of sponsoring a catalytic reaction as claimed in claim 3 wherein the ink formulation contains additional binders and/or fillers capable in use of enhancing the catalytic reaction.

5. A method of depositing a material onto a substrate in a user defined pattern by means of a catalytic reaction comprising the steps of:
i) preparing the substrate such that it is capable of sponsoring a catalytic reaction as claimed in any of claims 1 to 4 and
ii) exposing the prepared substrate from step (i) to a suitable reagent environment such that the catalytic reaction deposits material at the surface of the substrate.

6. A method of depositing a material onto a substrate in a user defined pattern by means of a catalytic reaction as claimed in claim 5 wherein the steps (i) and (ii) are repeated in order to deposit multiple layers of material onto the substrate.

7. A method of metal plating a substrate in a user defined pattern by an autocatalytic process comprising the steps of:
i) preparing a substrate material according to any of the preceding claims wherein the catalytic material is a deposition promoting material (as hereinbefore defined) which is capable, once the coated substrate is introduced into an autocatalytic solution, of facilitating the deposition of a metal coating from an autocatalytic solution onto the substrate, and,
ii) introducing the prepared substrate material from step (i) into an autocatalytic deposition solution, the autocatalytic solution comprising a metal salt and a reducing agent.

8. A method of metal plating a substrate by an autocatalytic deposition process as claimed in claim 7 comprising the further step of introducing the coated substrate from step (ii) of claim 7 into a further autocatalytic solution comprising a further metal salt and a reducing agent.

9. A method of metal plating a substrate by an autocatalytic deposition process as claimed in claim 7 comprising the further step of introducing the coated substrate material from step (ii) of claim 7 into an electrolytic bath in order to electrodeposit a further metal.

10. A method of metal plating a substrate by an autocatalytic deposition process as claimed in claim 7 wherein the autocatalytic solution contains two or more metals salts in solution.

11. A method of metal plating a substrate by an autocatalytic deposition process as claimed in claim 7 wherein the deposition promoting material comprises a reducing agent.

12. A method of metal plating a substrate by an autocatalytic deposition process as claimed in claim 7 wherein the deposition promoting material is SnCl₂.

13. A method of metal plating a substrate by an autocatalytic deposition process as claimed in claim 7 wherein the deposition promoting material comprises an activator comprising a colloidal dispersion of a catalytic material which is capable, once the substrate is introduced into an autocatalytic solution, of initiating and sustaining an autocatalytic reaction.

14. A method of metal plating a substrate by an autocatalytic deposition process as claimed in claim 7 wherein the deposition promoting material comprises a material that, once the substrate is introduced into an autocatalytic deposition solution, will undergo ion exchange with the metal salt in the autocatalytic deposition solution.

15. A method of metal plating a substrate by an autocatalytic deposition process as claimed in claim 7 wherein the method additionally comprises the step of introducing the substrate after it has been coated with the deposition promoting material into an aqueous metal salt solution with which the deposition promoting material will react to reduce the metal from the aqueous metal solution onto those parts of the substrate that have been coated with the deposition promoting material, the reduced metal being selected such that it is capable, once the treated substrate is introduced into an autocatalytic solution, of catalysing the deposition of a further metal from an autocatalytic deposition solution

16. A method of metal plating a substrate by an autocatalytic deposition process as claimed in claim 7 wherein the deposition promoting material comprises a combination of reducing agent and activator.

17. A method of preparing a substrate material for subsequent metal plating by an autocatalytic deposition process as claimed in any of claims 7 to 16 wherein the substrate material comprises a porous surface layer.

18. An ink formulation for carrying out the method of claim 3, the ink comprising a deposition promoting material and a solvent.

19. An ink formulation as claimed in claim 18 wherein the solvent is water, ester, alcohol or ketone based.

20. An ink formulation as claimed in claims 18 or 19 further comprising binder materials.

21. An ink formulation as claimed in any of claims 18 to 20 further comprising filler materials.

22. An ink formulation as claimed in claim 20 wherein the binder material comprises poly(vinyl acetate) polymers.

23. An ink formulation as claimed in claim 20 wherein the binder material comprises acrylic polymers

24. An ink formulation as claimed in claim 20 wherein the binder material comprises poly(vinyl alcohol) polymers.

25. An ink formulation as claimed in claim 21 wherein the filler material comprises insoluble particles which are arranged in use to be capable of transferring from the pattern transfer mechanism to the substrate.

26. An ink formulation as claimed in claim 25 wherein the filler particles are coated in catalytic material.
